(19) United States
(12) Patent Application Publication
(10) Pub. No.: US 2026/0342273 A1
(43) Pub. Date: Oct. 29, 2026

(54) ROOF MOUNT WITH RELEASE MECHANISM

(71) Applicant: Pegasus Solar Inc, Richmond, CA (US)

(72) Inventors: Ian Wogan, Richmond, CA (US); Erich Kai Stephan, Richmond, CA (US); Ian Lennox, Richmond, CA (US)

(21) Appl. No.: 19/736,810

(22) Filed: Jul. 9, 2026

Related U.S. Application Data
(62) Division of application No. 18/788,119, filed on Jul. 29, 2024.
(60) Provisional application No. 63/529,343, filed on Jul. 27, 2023.

(51) Int. Cl. H02S 20/23; E04D 1/36

(52) U.S. Cl. CPC H02S 20/23; E04D 1/36

(57) ABSTRACT

A system and a method of securing and sealing a roof attachment to a roof surface is disclosed. A roof attachment may include a base, a protective covering, volume of sealant, and a release mechanism. The release mechanism includes one or more release slides. The release slides may have one or more mechanism apertures to receive a fastener. The release slide may have one or more flexible tabs that cooperate with one or more indentation or flanges or grooves in base to substantially retain the release slide.

### CROSS-REFERENCE TO RELATED APPLICATIONS

This application is a divisional of U.S. patent application Ser. No. 18/788,119 filed Jul. 29, 2024, which claims the priority benefit of U.S. provisional patent application 63/529,343 filed Jul. 27, 2023, the disclosure of which is incorporated herein by reference.

### BACKGROUND

Current roof attachments typically require some method of preventing water intrusion where the roof is penetrated to secure the attachment, such as a hole for a fastener. Often roof attachments use a Sealant, or caulking applied during the installation of the roof attachment, or a flashing to divert water flow away from roof penetration, or both. The on-roof application of Sealant can be time consuming and messy, and the use of a flashing can be expensive and cause un-intended damage. The present invention demonstrates a cleaner, faster, and more cost-effective way to secure and seal a roof attachment to a roof surface.

### SUMMARY OF THE PRESENTLY CLAIMED INVENTION

A system and a method of securing and sealing a roof attachment to a roof surface is disclosed. A roof attachment may include a base, a protective covering, volume of sealant, and a release mechanism. The release mechanism includes one or more release slides. The release slides may have one or more mechanism apertures to receive a fastener. The release slide may have one or more flexible tabs that cooperate with one or more indentation or flanges or grooves in base to substantially retain the release slide.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIGS. 1A and 1B depict an isometric exploded and isometric assembled views representing an example embodiment of the present invention.

FIG. 2A-2D depict plan and end views of the present invention representing one example embodiment.

FIGS. 3A and 3B depict an isometric view of roof attachment in a complete and a cut-away view in an assembled state.

FIGS. 4A and 4B depict an isometric view of roof attachment in a complete and a cut-away view in an unlocked state.

FIGS. 5A-5C depict an isometric view of roof attachment in a complete and a cut-away view in an installed state 500.

FIGS. 6A and 6B depict an exemplar embodiment of the present invention illustrating base 101 in a top-down view.

FIG. 6C depicts an exemplar embodiment of the present invention illustrating an underside view.

FIGS. 7A-7C depict an isometric view of a cut-away side section of roof attachment.

FIGS. 8A-8C depict an isometric view of a cut-away side section of roof attachment.

FIGS. 9A and 9B depict an isometric cut-away section of roof attachment 100 to demonstrate the interaction between one or more 105 and base 101.

FIG. 10A-10C depict an isometric exploded view and assembled view of an alternative example of roof attachment.

FIGS. 11A-11I, 12A, 12B, 13A, 13B, 14A-14D, 15A-15D, 16A-16D, 17A-17D, and 18A-18F each depict an alternative embodiment of roof attachment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

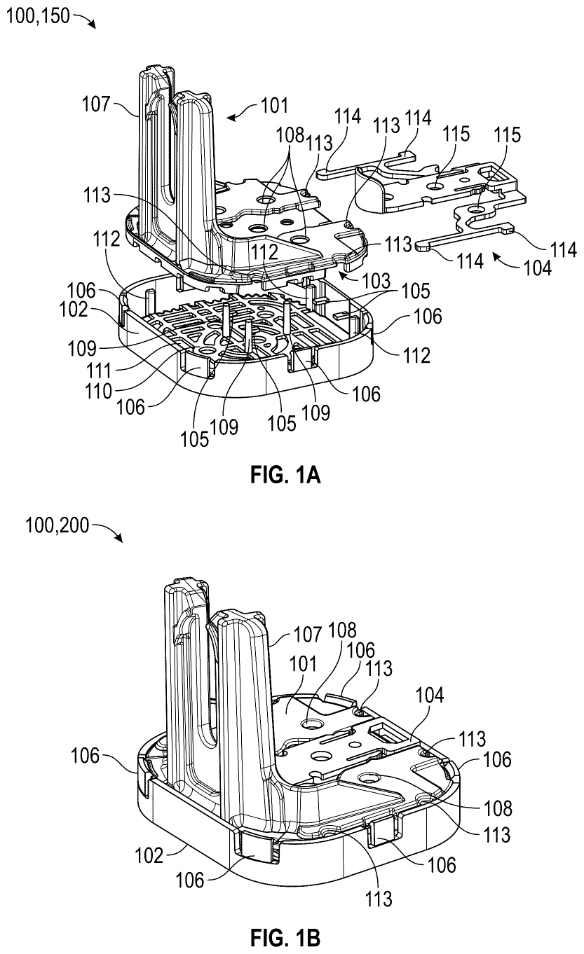

FIGS. 1A and 1B depict an isometric exploded and isometric assembled views representing an example embodiment of the present invention. Roof attachment 100 may have a base 101, protective cover 102, volume of sealant 103 (not shown), and one or more release slide 104. In some example embodiments, protective cover 102 and release slide 104 may be integrated into one component, and in other example embodiments they may be separate components, as depicted. Roof attachment 100 may have several states, such as an unassembled state 150, an assembled state 200, an unlocked state 400, and an installed state 500. FIG. 1A depicts roof attachment 100 in an unassembled state 150, and FIG. 1B depicts roof attachment 100 in an assembled state 200.

One or more stop-tabs 105 may be disposed around a perimeter wall of protective cover 102. The stop-tabs 105 may protrude in towards the center of protective cover 102 and may be configured to support and retain base 101 in conjunction with Retaining Clips 106 also disposed along the perimeter wall of protective cover 102. A mesh 110 may be disposed across the bottom surface of protective cover 102, with a plurality of mesh apertures 111 disposed across its surface as shown. The mesh apertures 111 may be of different sizes and configurations. One or more of the mesh apertures 111 may be configured to allow a similarly shaped protrusion extending from the underside of base 101 to pass through (not shown). The mesh apertures 111 may be sized to generally prevent an adult human finger from readily passing through, yet large enough to allow sealant 103 to flow through when compressed down by the force of a first fastener 501 engaging a roof surface and base 101. One or more pillars 109 may extend up from mesh 110 and configured to pass through one or more apertures disposed on the surface of base 101. One or more stop-tabs 105 may also be disposed on the pillars 109 as shown.

One or more support columns 112 may be disposed around the perimeter wall of protective cover 102. The support columns 112 may be configured to pass through a respective one or more column apertures 113 disposed in the surface or edges of base 101. One or more interference tabs 114 may be disposed on the release slide 104, and when roof attachment 100 is in an assembled state 200, the interference tabs 114 are positioned between the support columns 112 and column apertures 113, thereby preventing the support columns 112 from readily passing through the column apertures 113. The interference tabs 114 may partially cover column apertures 113 or may fully cover interference tabs 114. The support columns 112, column apertures 113 and respective interference tabs 114 may be positioned on protective cover 102 and base 101 in order to substantially even distribute a downward load applied to base 101. The top edges of support columns 112 may have a radiused or chamfered edge to more easily guide into and through a column aperture 113. Support columns 112 may have a tapered cross-section as measured from the bottom surface of protective cover 102 (i.e., near the 110) to the top of the perimeter wall.

Base 101 may have a primary horizontal body and one or more vertical flanges 107 extending perpendicular or at a slight angle (such as less than 10 degrees) from the primary horizontal body. As shown in the figure, a single vertical flange 107 is shown with a plurality of ribs disposed on various sides connecting between the vertical flange 107 and base 101. In other embodiments not shown, there may be no vertical flanges 107, and base 101 may be a substantially flat plate, a plate with one or more recessed features, a plate with one or more protrusions or flanges extending out at an angle relative to base, or another configuration. From a top-down view, base 101 may be square as shown, or circular, oval, hexagonal, rectangular, a rhombus, or other polygon, with or without radiused or chamfered corners, or some combination thereof. One or more fastener apertures 108 may be disposed on the top surface of base 101. The fastener apertures 108 may be a circular shape, oval shape, or slot shaped, and may have a radiused or chamfered perimeter edge leading onto the top surface of base 101. The bottom surface of the fastener apertures 108 may be a thin wall of material such that a fastener may readily pierce through by hand force, or a cutting tip disposed on a leading distal end of a fastener. The thin wall may have a convex shape to center the leading distal end of a fastener prior to the fastener piercing the thin wall. In other example embodiments, the one or more fastener apertures 108 may instead be configured as an aperture extending through the surface of base 101 with no thin wall.

Protective cover 102 may have a perimeter wall wherein outside surface 350 and inside surface 351 may not be parallel with one another but form an acute or obtuse angle. In this way, protective cover 102 may be manufactured in a die with two halves that may pull apart while not deforming or scratching the perimeter wall. Protective cover 102 may be manufactured from a variety of techniques using a variety of materials, such as high pressure die casting, investment casting, vacuum die casting, injection molding, blow molding, machining, 3D-printing, stamping, progressive die, additive manufacturing methods, or other suitable techniques. Protective cover 102 may be made form a polymer and may have ultra-violet light stability adding compounds. Base 101 may be made from aluminum, steel, stainless steel, polymers, plastics, resins, glass-reinforced resins, carbon-reinforced resins, or other suitable materials.

Release slide 104 may have one or more mechanism apertures 115 disposed on the top surface configured to receive a fastener. Release slide 104 may have a uniform wall thickness and may have one or more edges as viewed from a cross section that is at an obtuse or acute angle relative to primary flat surface. In other words, the cross section of one or more areas of release slide 104 may be trapezoidal or curved, rather than rectangular or square.

Release slide 104 may have one or more flexible tabs that cooperate with one or more indentations or flanges or grooves in base 101 to substantially retain the release slide 104 in a first position of an assembled state 200 to a second position of an unlocked state 400.

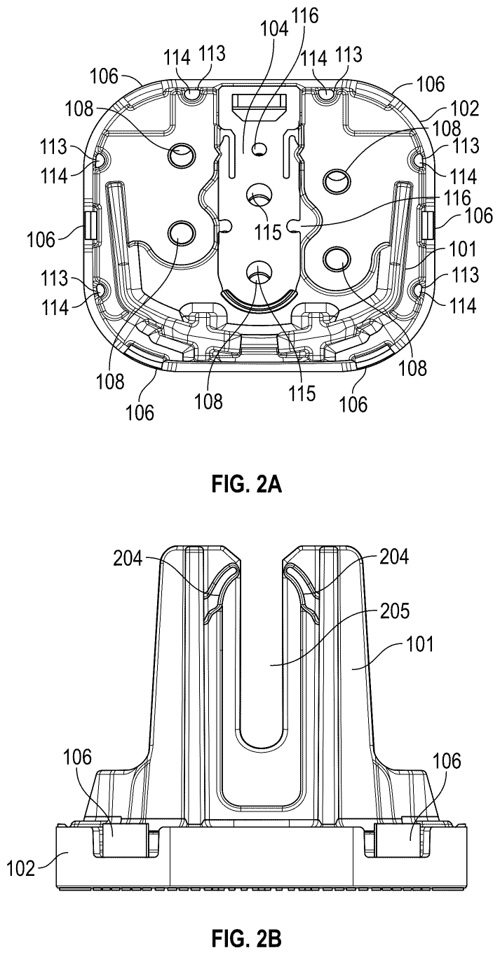

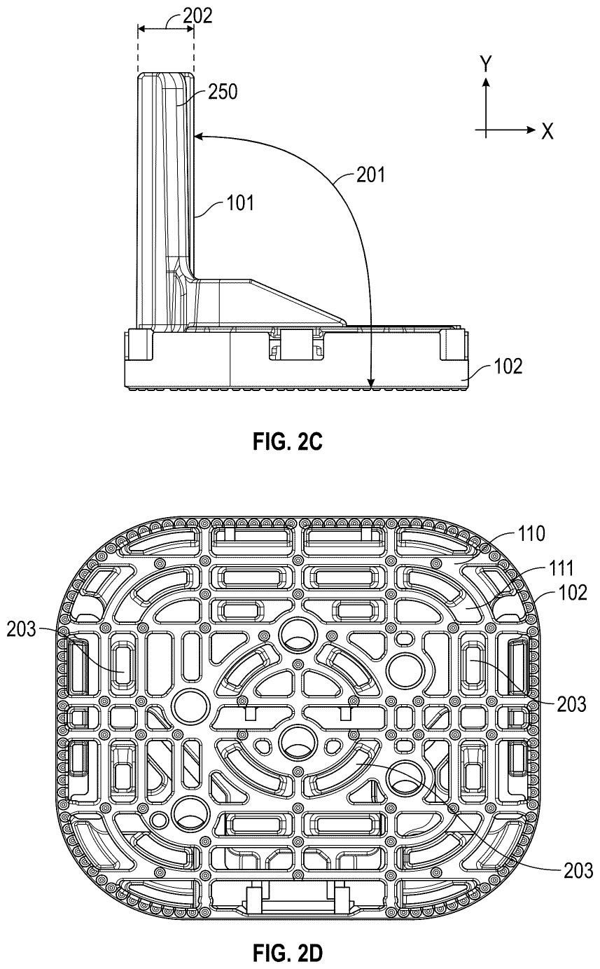

FIG. 2A through 2D depicts plan and end views of the present invention representing one example embodiment. Angle 201 may be perpendicular, such as 90 degrees, between the bottom surface of protective cover 102 or the bottom of base feet 203, or it may be set an acute angle between 85-89 degrees. Draft angle 202 may be greater than 0 degrees, such as 1 to 10 degrees, between the primary vertical surfaces of the vertical flange 107. A plurality of base feet 203 may be disposed on the underside surface of base 101, extending a substantially similar distance from the underside of base 101 such that the distal faces are substantially planar. The plurality of base feet 203 may be configured to pass through the plurality of mesh apertures 111. A flange aperture 205 may be disposed laterally through vertical flange 107 in an open-ended aperture configuration, as shown, or a closed aperture configuration, not shown. In some example embodiments, one or more nut flanges 204 may be disposed near the distal end of flange aperture 205. Nut flanges 204 may be configured to prevent the flange of a nut or fastener (such as a flange bolt) that is tightened against the vertical flange 107 from readily sliding out of the flange aperture 205.

Sealant 103 may be applied onto the underside surface of base 101, and protective cover 102 may then be aligned with base 101. In an example assembly process, the roof attachment 100 may begin in an unassembled state where the primary components consisting of base 101, protective cover 102, sealant 103, release slide 104, and one or more 501 are loose, unassembled, and unassociated components. In some embodiments, the primary components may come from a variety of different manufacturing suppliers or sources. In transforming roof attachment 100 from an unassembled state to an assembled state 200, base 101 may be placed in a fixture, including a stationary or a robotic assembly line-type fixture. Base 101 may be positioned upside down, wherein the underside of base 101 is facing substantially away from Earth-center. Then, sealant 103 may be disposed onto the underside surface in one or more circular, ovoid, square, polygon, line, dot, dollop or other similar shapes or patterns. Sealant 103 may have a prescribed volume disposed on the surface, controlled for example, by an electronic or pneumatic dispenser. In another application process, sealant 103 may be disposed using a manual process, such as using a caulking tube or syringe. Sealant 103 may be disposed to form a substantially desired, or programmed, shape, thickness, width, or curvature to achieve a desired volume.

In a potential next step, protective cover 102 may be aligned over the underside of base 101. Alternatively, protective cover 102 may be in a fixed position and base 101 with pre-applied sealant 103 may be positioned to align over protective cover 102. Protective cover 102 then may be pressed onto base 101 such that one or more lock-tabs 106 engage and/or cooperate with a lip, groove, flange, chamfer, radius, or similar engagement feature on base 101 to prevent protective cover 102 from readily de-coupling off base 101 in a reverse direction after engagement.

Protective cover 102 may have one or more stop-tabs 105 that are positioned to interfere with base 101 when the lock-tabs 106 are substantially engaged. The one or more stop-tabs 105 may also engage, or nearly engage with base 101 to prevent protective cover 102 from traversing further onto or over base 101. For example, one or more stop-tabs 105 may interfere with the bottom surface of base 101. Protective cover 102 may have a geometry such that one or more stop-tabs 105 prevent all or a portion of protective cover 102 from touching sealant 103. Likewise, the thickness of sealant 103, as measured perpendicular to the underside surface of base 101, may have a height such that sealant 103 does extend below the lower exterior edge or beyond a screen, flanges, ribs, feet, or mesh apertures 111 or similar features on protective cover 102 once stop-tabs 105 of protective cover 102 engage the underside base 101. The perimeter wall of protective cover 102 may have a thickness less than the diameter of typical pilot hole for the Roof Fastener.

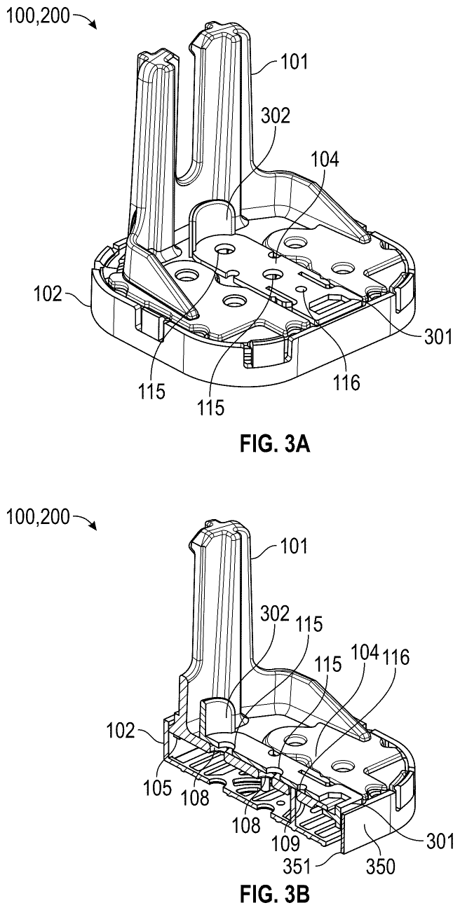

FIGS. 3A and 3B depict an isometric view of roof attachment 100 in a complete and a cut-away view in an assembled state 200. In this view, sealant 103 has been hidden for ease of visualization. As shown, the release slide 104 is in a locked position 301, wherein the one or more mechanism apertures 115 are not substantially cordial with the respective fastener apertures 108. In 301, the interference tabs 114 prevent the support columns 112 from passing through the respective column apertures 113. Tab 302 is disposed near the end of the release slide 104.

In this assembled state 200, sealant 103 (not shown) has been applied to the underside of base 101, and protective cover 102 has been installed onto base 101 such that the lock-tabs 106 have engaged with base 101, and the stop-tabs 105 have or are nearly engaged with base 101. As an example, an intentional tolerance may be allowed for a gap to remain between base 101 and the stop-tabs 105 when the lock-tabs 106 engage, or alternatively, an intentional interference-fit may occur between the stop-tabs 105 and base 101 when the lock-tabs 106 engage with base 101. In the assembled state 200, sealant 103 is in an un-compressed state, where it may form a dome-like shape when viewed in a cross-section. In this un-compressed state, sealant 103 may have a tapered shaped such that a thinner cross-section is near the lower edge (i.e., furthest from base 101) and a wider cross-section near the upper edge (i.e., at sealant 103 and base 101 interface). The cross-sectional shape of sealant 103 could be a sideways “D” shape, a trapezoidal, pyramidal, ovoidal, circular, half-ovoidal, half-circular, or similar shape. Sealant 103 may have a shape or a width in the unlocked state 400 state, that upon base 101 being compressed onto the roof surface as roof attachment 100 transitions to an Installed State, sufficient pressure is induced onto sealant 103 to allow base 101 to fully seat on to the roof surface and sealant 103 to flow substantially throughout the projected area of the foot, and in some embodiments, beyond the perimeter wall of protective cover 102.

Sealant 103 may be a substance meant to prevent water from accessing a roof penetration where a fastener is located to secure roof attachment 100 to the Roof Surface. Additionally, sealant 103 may have characteristics to fill voids or cracks on the underlying roof surface, such as a gap between asphalt shingles, or to fill vacant holes in the roof such as unused pilot holes. Sealant 103 may have properties of being waterproof, water resistant, weatherproof, or to repel water. In example embodiments of the present invention, sealant 103 may be an isobutylene compound, a butyl-based rubber sealant, a non-skinning or minimally skinning sealant, a non-sag or minimally-sag sealant, or a combination thereof. Sealant 103 may have a defined viscosity or ingress protection rating to prevent sealant 103 from readily flowing beyond protective cover 102 or through mesh apertures 111 when roof attachment 100 is in any orientation (such as a bulk packed package) in elevated temperatures, such as 140 degrees Fahrenheit, while also having a viscosity that still allows sealant 103 to flow around a Roof Fastener or through a Mesh 110 or into voids in the roof in colder climates when being installed, such as when installing on a sub-freezing roof top. Sealant 103 may have properties of being permanently or semi-permanently flexible, maintain a permanent or semi-permanent surface tack, be self-healing, or a combination thereof. In another example embodiment of the present invention, sealant 103 may have desired time period, such as 1-year, to maintain a desired flexibility, maintain a surface tack, be self-healing, or a combination thereof. Sealant 103 may maintain flexibility at low temperatures and may be designed to perform in its intended use, transitioning from an Unlocked state 400 to an Installed State, in temperatures ranging from 0 degrees to 180 degrees Fahrenheit. Sealant 103 may have a specific color, such as off-white, dark gray, or blue, such as for the purpose of visually blending into the average hues and colors of the roof surface, or visually contrasting with the average hues and/or colors of the roof surface or a protective cover 102. Alternatively, sealant 103 may intentionally have a color that contrasts with the color of protective cover 102 and or roof surface in order to readily provide visual confirmation of base 101 transitioning between a Unlocked state 400 and an Installed State if Sealant 103 ejects outside of the perimeter, edge, or surface of protective cover 102 or base 101 such that a portion of sealant 103 is visible to the person installing the roof attachment 100. Sealant 103 may be a non-hardening sealant 103, maintaining a liquid or semi-liquid state for a prolonged period of time, such as 1 or 10 years. Sealant 103 may have a low viscosity, or have a cure time greater than 1, 5, or 10 years. Sealant 103 may have an asymptomatic cure time, wherein it hardens over time but never fully cures. In other words, sealant 103 may increase in viscosity, decrease in flexibility, decrease in tack, decrease in adhesion, or change state, or a combination thereof over time. Sealant 103 may remain tacky for an extended period of time, such as 10 or 30 years, such that sealant 103 will maintain a water-resistant barrier with the roof surface. Sealant 103 may have a chemistry to be compatible with a variety of roofing materials, such as asphalt, composite asphalt, composite shingle, tar paper, roofing paper, tar roof, TPO, PVC, Hypalon, Kynar, painted metal, fiberglass, stone-coated steel, clay, ceramic, glass, concrete, cement, and other common roofing materials. Sealant 103 may reduce in viscosity at temperatures above the room temperature, with one purpose being to more readily disperse a bead of Sealant 103 onto the underside of base 101 during assembly, e.g., when transitioning roof attachment 100 from an Unassembled state to an Assembled state 200.

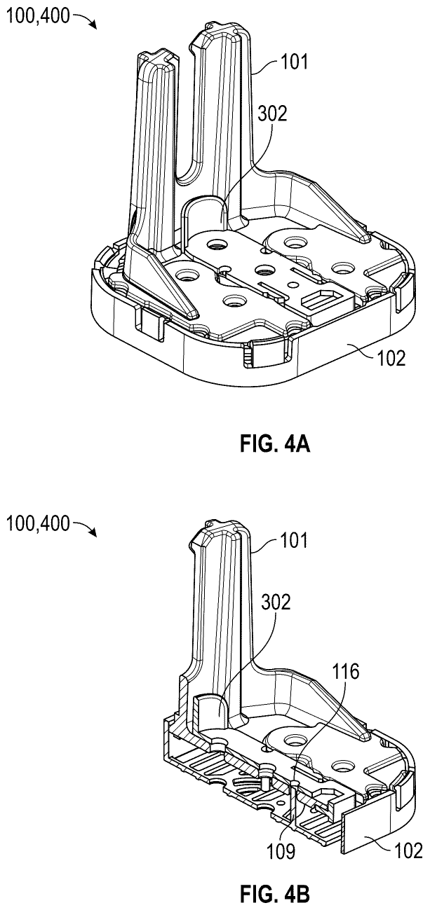

FIGS. 4A and 4B depict an isometric view of roof attachment 100 in a complete and a cut-away view in an unlocked state 400. In this view, sealant 103 has been hidden for ease of visualization. Release slide 104 has traversed laterally such that the interference tabs 114 substantially does not cover column apertures 113, thereby allowing the respective support columns 112 to pass through. Additionally, one or more mechanism apertures 115 are now substantially aligned with the respective fastener apertures 108 in order to allow a fastener to readily pass through, including if a fastener is used to pierce a thin wall of a fastener apertures 108. One or more 109 are substantially aligned with one or more respective pillars apertures 116. The method of changing roof attachment 100 from a 200 to an unlocked state 400 may be to press on a 302 in order to slide a release slide 104 laterally, as shown in the difference between FIGS. 3 and 4. 302 may be configured to easily press on by an average human thumb or finger, or by a common tool, such as a screwdriver.

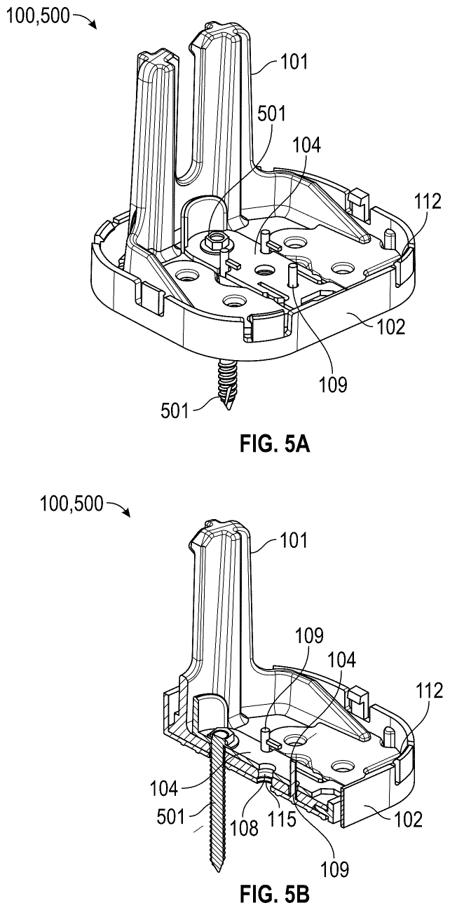

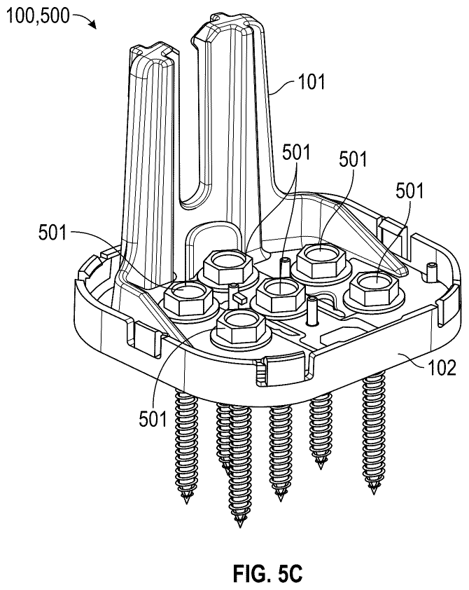

FIGS. 5A and 5B depict an isometric view of roof attachment 100 in a complete and a cut-away view in an installed state 500. In this view, sealant 103 has been hidden for ease of visualization. A first fastener 501 has been installed through a first mechanism apertures 115 and fastener apertures 108. Fastener 501 may have threadably engaged with a roof surface (not shown) to pull base 101 down relative to the body of protective cover 102 until the plurality of base feet 203 contact a roof surface. The force from a first fastener 501 threadably engaging the roof surface may impart enough downward force to flex or break away the one or more stop-tabs 105, as well as to compress sealant 103 through the plurality of mesh apertures 111 and onto the roof surface. In FIG. 5C, a second or more additional fasteners 501 are installed into one or more vacant fastener apertures 108. As viewed from the top, no two fasteners 501 may be in the same plane—in other words the 501 may be in different distances between the gutter and ridge of a roof surface.

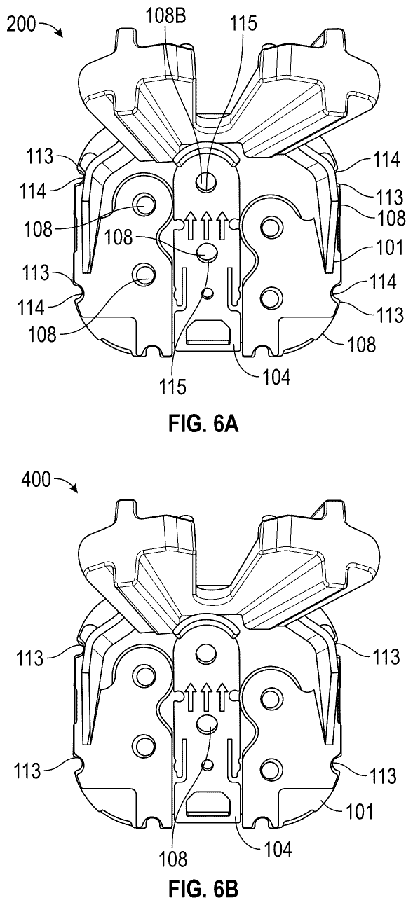

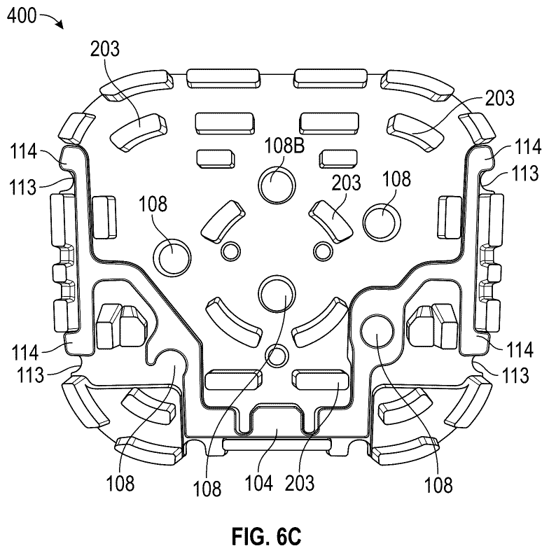

FIGS. 6A and 6B depict base 101 in a top-down view and 6C in an underside view, with sealant 103 and protective cover 102 removed for ease of visualization, representing one example embodiment of the present invention. In FIG. 6A, base 101 is in a assembled state 200. In FIG. 6B, base 101 is in an unlocked state 400. In FIG. 6C, base 101 is in an unlocked state 400. As depicted, fastener apertures 108B has no thin wall across the indentation and may be configured to accept a first fastener 501 without interference upon base 101 transitioning to an unlocked state 400. The remaining fastener apertures 108 (5 additional fastener apertures 108 depicted as an example in the figure), may have a thin wall that is pierceable by fastener 501. In FIG. 6C, the underside of the fastener apertures 108 are visible.

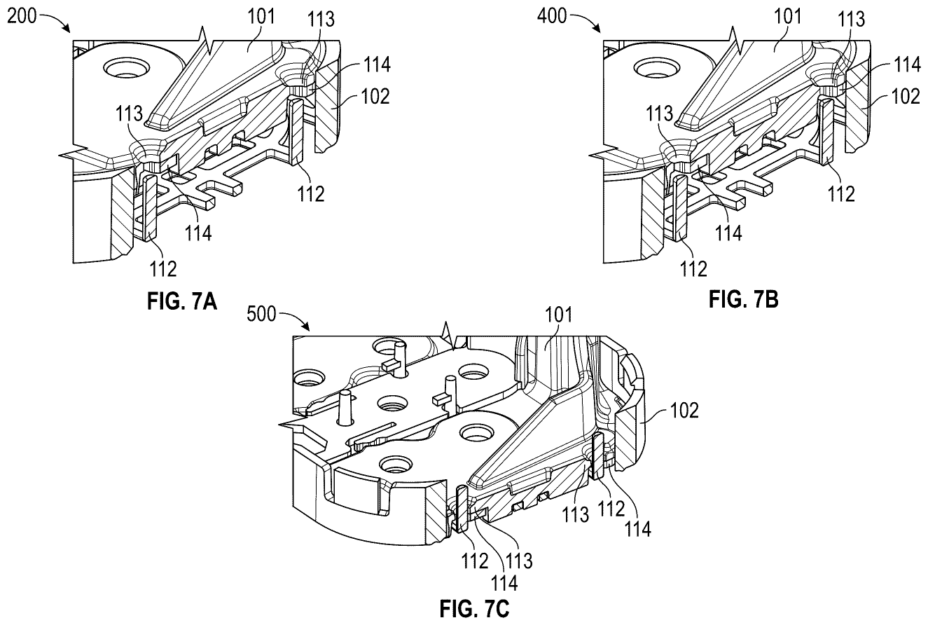

FIGS. 7A through 7C depict an isometric view of a cut-away side section of roof attachment 100 to expose the interaction between the support columns 112, column apertures 113, and interference tabs 114. Sealant 103 has been hidden for ease of visualization. In FIG. 7A, roof attachment 100 is in a assembled state 200, and the one or more interference tabs 114 block the respective support columns 112 from passing through the respective column apertures 113. In this figure, only two sets of support columns 112, column apertures 113, and interference tabs 114 are visible, but more may be used on other areas of roof attachment 100. In FIG. 7B, roof attachment 100 is in an unlocked state 400, and the one or more interference tabs 114 have traversed to allow the respective one or more support columns 112 to slide through a respective column apertures 113. In FIG. 7C, roof attachment 100 is in an installed state 500, and fastener 501 is hidden for ease of visualization. The one or more one or more column apertures 113 have traversed partially down the respective support columns 112 until base 101 has contacted a roof surface.

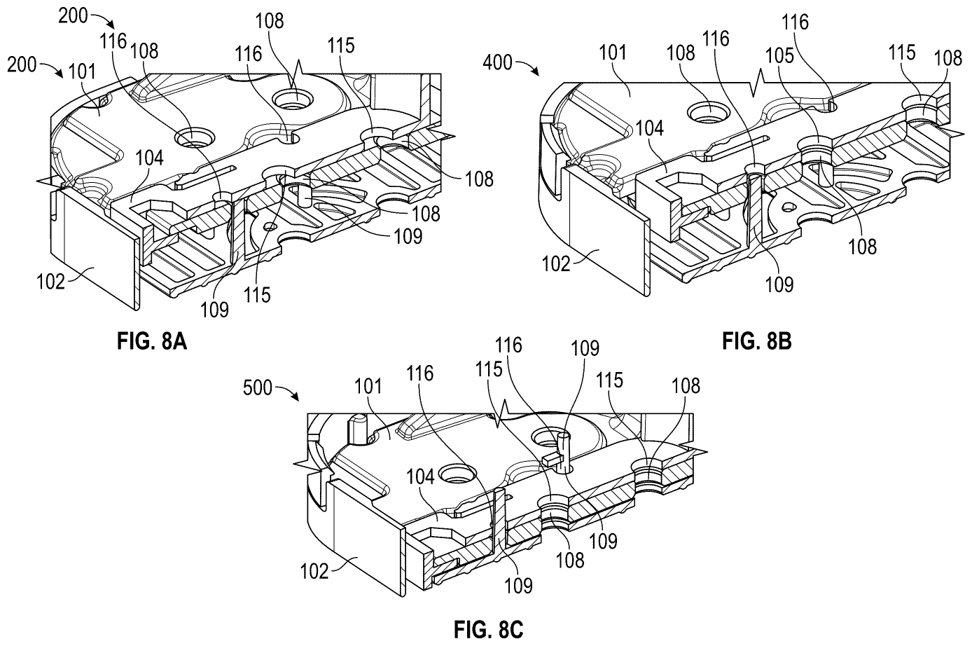

FIGS. 8A through 8C depict an isometric view of a cut-away side section of roof attachment 100 to expose the interaction between the pillars 109 and pillar apertures 116. Sealant 103 has been hidden for ease of visualization. In FIG. 8A, roof attachment 100 is in a 200, and the one or more pillar apertures 116 are offset from being aligned with a respective one or more pillars 109, and one or more support columns 112 are blocked from traversing through one or more respective column apertures 113 by one or more interference tabs 114. One or more mechanism apertures 115 are also not aligned with a respective one or more fastener apertures 108. In FIG. 8B, roof attachment 100 is in an unlocked state 400, and the release slide 104 has traversed such that the pillars apertures 116 may be aligned with a pillars 109 such that the pillars 109 may pass through. One or more mechanism apertures 115 are now substantially aligned with a respective one or more fastener apertures 108 in order to allow a 501 to readily reach a fastener apertures 108 unobstructed by a mechanism apertures 115. Interference tabs 114 have traversed laterally to allow one or more support columns to pass through one or more column apertures 113 unobstructed. In FIG. 8C, roof attachment 100 is in an installed state 500, and the one or more pillars apertures 116 have traversed partially down the length of the respective one or more pillars 109 until base 101 has contacted a roof surface. Fastner 501 is hidden for ease of visualization.

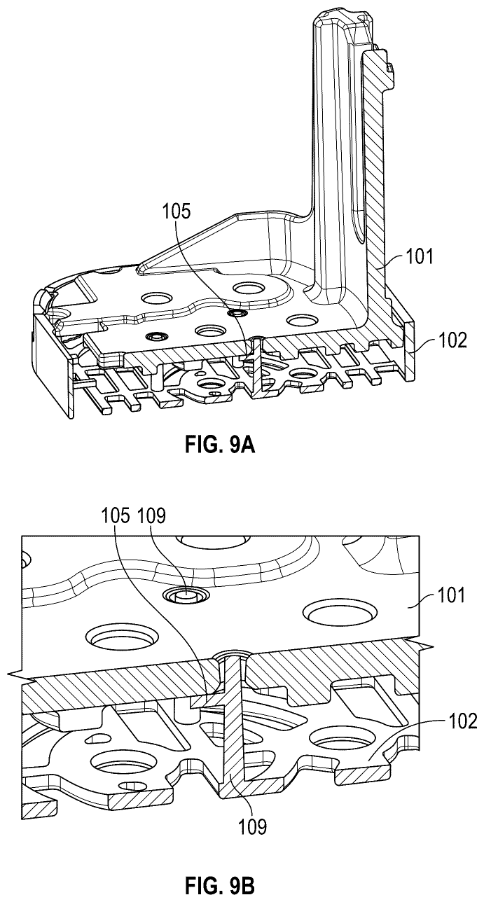

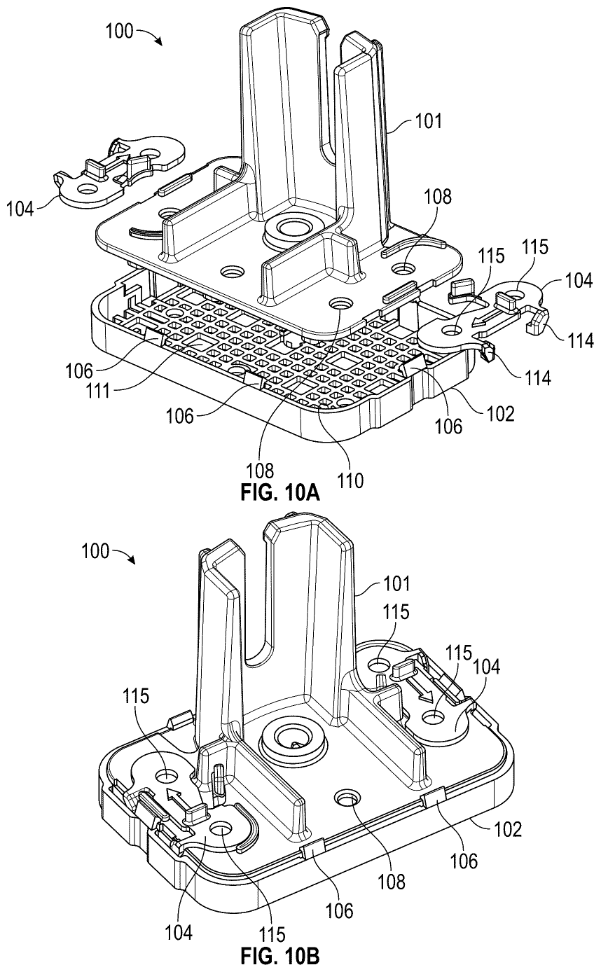

FIGS. 9A and 9B depict an isometric cut-away section of roof attachment 100 to demonstrate the interaction between one or more 105 and base 101.

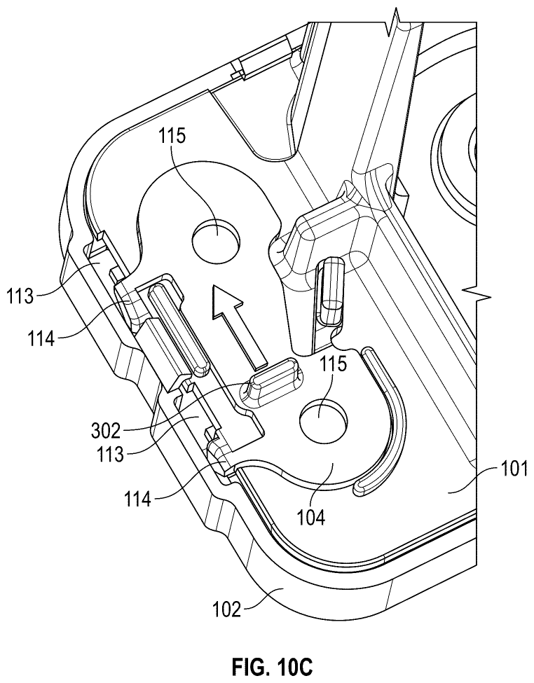

FIGS. 10A, 10B, and 10C depict an isometric exploded view and assembled view of an alternative example of roof attachment 100 representing another example of the present invention. In this example embodiment, two release slides release slide 104 are positioned on the sides of base 101. The release slide 104 may traverse along the body of base 101 in opposite directions, as indicated, or in the same direction. The one or more release slide 104 may each have a 302 for sliding each release slide 104 a desired distance.

On the top surface of base, Lock-Feature may be formed to cooperate with the Lock-tabs 106 of protective Cover 102. The Lock-Feature may be a chamfered corner on one or more portions of base, or around the entire perimeter of base. Alternatively, the Lock-Feature may be a radius, step, lip, groove, flange, recess, or other geometry designed to cooperate with one or more Lock-tabs 106. When viewed such that the Perimeter Feet are on a flat plane, such as a roof surface, the Vertical Flange 107 and one or both of the wider faces may be substantially perpendicular to plane. The top surface of base may form an angle with the plane, such that the surface of base and the inner face of the Vertical Flange form an obtuse angle. The side thinner faces of the Vertical Flange may have a parting line along their length such that a first portion of the side face forms an acute angle with the nearer large face of the Vertical Flange, and a second portion of the side face forms an acute angle with outward facing large face of the Vertical Flange. One or more Ribs may extend from the Vertical Flange in either the Y, X or both directions, in a linear or a curved shape, as shown in FIG. 5A. The Ribs may be solid or may be hollow. For Ribs that extend towards the Fastener apertures 108, such ribs may have a truncated height that is tangent or lower than the bottom point of the Flange Aperture. In this way, a Rail can be installed flush to the inner face of the Vertical Flange in a lowest position in the Flange Aperture, and not interfere with the Ribs.

A Parting Line may form a plane that bisects Base 101 fully or partially along the Z axis. In the FIG. 5A, the Parting Line forms a plane defined by the Y and Z Axis in the associated coordinate plane. The Parting Line Plane 250 may be positioned along the X axis to bisect the Vertical Flange, either in its mid-point or offset to one side of the Vertical Flange. In one example of the present invention, surfaces above base may form either an obtuse angle, or be parallel, with the Parting Line Plane 250 in order to aid in the manufacturability of the part using a mold, such as in a cast part. In another example of the present invention, the Parting Line Plane 250 may be defined by the Y axis and an angle relative to the Z axis (i.e. the Plane is rotated about the Y axis) so that the top side of base 101 may be at an obtuse angle with the Parting Line Plane 250 and also parallel with the Underside Surface of base. A Slide Plane may be defined by the X and Y axis and may be located along the Z axis with a portion of the Slide Plane coincident with the Underside Surface of base 101. Surfaces in the negative Z direction from the Slide Plane may form either an obtuse angle with the Slide Plane, such as the side surfaces of base feet 203, or may be substantially parallel with the Slide Plane, such as the bottom surface of base feet 203.

The Flange Aperture may be formed through the Vertical Flange, and may be a circular hole, a slotted hole closed on both ends of the slot, or a slotted hole with one end open to the top of the Vertical Flange, as shown. The Vertical flange may be configured to receive a fastener through to secure a Rail to the Roof Attachment. The Flange Aperture may have a recessed surface on one or both sides, wherein the recessed surface forms a perimeter lip. The recess may be configured to allow the flange of a nut to reside within the recess, such that the flange of the nut may interfere with the perimeter lip to prevent the nut from readily sliding out of the Flange Aperture in the positive Z direction. The lip may be around the entire perimeter of the Flange Aperture or may be only at the top section of the Flange Aperture to prevent a nut and fastener from readily sliding out of the Flange Aperture in the positive Z direction. The Recess may have Fastener Serrations disposed on its surface to cooperate with serrations on a Nut to prevent the Nut from readily decoupling from a fastener after the Nut is tightened against the Recess. The Vertical Flange may have one or more Flange Serrations on one or more surfaces.

Base 101 may be manufactured from a variety of techniques using a variety of materials, such as high pressure die casting, investment casting, vacuum die casting, injection molding, extrusion, machining, turning, forging, additive manufacturing methods, or other suitable techniques. Base 101 may be made from aluminum, steel, stainless steel, polymers, plastics, resins, glass-reinforced resins, carbon-reinforced resins, or other suitable materials.

The bottom of protective Cover may consist of a series of Ribs that form a Mesh 110 or screen-like plane. The Mesh 110 may take the form of a grid-like pattern, a honeycomb pattern, or a complex pattern. As depicted in FIG. 6C, the Ribs may form an inner shape that roughly matches the shape of the Perimeter Wall, and then inside the inner shape the Mesh 110 has a grid-like pattern. The Mesh 110 may have all or a portion of its bottom surface coincident or offset from the bottom surface of the Perimeter Wall. One or more Fastener apertures 108s may be disposed throughout the Mesh 110 to allow a fastener to pass-through a Fastener aperture 108 on base 101 and Protective Cover.

Protective Cover may be made from a polymer, EPDM rubber, silicon, other rubber, injection molded plastic, a cast metal, such as aluminum, carbon or stainless steel, or another suitable material. Protective Cover may have no additional coatings, or it may have a coating, such as paint. The Perimeter wall may have a cross-sectional shape there the two primary walls are not parallel with one another, but rather form an obtuse or acute angle.

The one or more type of Stop Tabs 105 coincides with the underside of base 101 to help in the Assembled state 200 to prevent base 101 from traversing through protective Cover 102. The Stop Tabs may be flexible resilient members, substantially re-forming to their original state after base 101 has traversed through protective Cover until bottoming out with the Mesh 110. In another example embodiment, the Stop-tabs 105 may break, snap, yield, dislodge, or permanently bend after base 101 traverses through protective Cover until bottoming out with the Mesh 110. The Stop Tabs may have enough strength to prevent protective Cover from flexing or traversing up base 101 such that sealant 103 coincides with the Mesh 110 while one or more Roof Attachments are being transported to a final installation site. In other words, the Stop-tabs 105 may have enough resilience to withstand the weight of not only base 101, but also several Base 101s that may be stacked on top, i.e., in packaging. The Stop-tabs 105 may have an upper strength or resilience such that they bend, break, deflect, or otherwise allow base 101 to traverse through protective Cover upon one or more Fasteners 501 engaging a roof surface and compressing base 101 onto the Roof Surface.

The Mesh 110 may be configured to cooperate with base feet 203 or any protrusions on the underside surface of base 101 such that the Mesh 110 partially or fully nests within the protrusions when roof attachment 100 is in an Installed State.

Fastener 501 may have a hex head shape, a star or hex shaped interior cavity, and may have no flange or it may have a flanged head.

The volume and shape of Sealant 103 disposed on base 101 during the assembly process (e.g. transition from Pre-Assembled State to Assembled state 200) may be varied to match the volume of space under base 101 in the Installed State (e.g. thus occupying the remaining space between the Mesh 110 and Base feet 203 of base 101), to exceed the volume of space, or to be less than the volume of space. As an example, roof attachment 100 may be configured to have a volume of Sealant 103 greater than the volume of space under base 101 in the Installed State in order to intentionally result in Sealant 103 ejecting beyond the Perimeter Wall of protective Cover.

In other example embodiments not shown, base 101 has no vertical flange. Base may have one or more Fastener apertures 108s configured on a platform portion of base. The platform is configured to support various accessories, such as an L-shaped bracket, a conduit support strap, a plumbing strap, an attachment bracket or pipe for HVAC units, or numerous other applications. In another example embodiment not shown, one or more additional threaded holes may be disposed on the top of base 101 to receive and engage with a threaded fastener, such as a bolt.

In other example embodiments not shown, Base 101 may have a cross section that is the same shape along its entire length, except for one or more Fastener apertures 108s and/or Flange Apertures disposed orthogonal to the cross section. Base 101 in this example embodiment may be made from an extrusion, casting, machining, forging, roll forming, bending, stamping or other suitable process, and may be made from aluminum, steel, stainless steel, plastic, a synthetic polymer, or other suitable material. Functioning the same as the Roof Attachments previously described, a volume of Sealant 103 may be disposed on the underside of base 101, and a Protective Cover may be secured onto base 101 with one or more Lock-tabs 106 and Stop-tabs 105 as previously described. The Flange Aperture in this example embodiment of base 101 may be a closed slot, as shown, or may be an open slot with the top end of the slot open to the top of base 101 such that a fastener could traverse down the slot from the top of base 101.

In yet another example embodiment not shown, a Protective Cover is replaced with one or more Flexible Resilient Members. Sealant 103 may be similar in shape and cross section as described in earlier embodiments or may be a uniformly thick plane as shown. Roof Attachment may be placed on a roof surface with the Flexible Resilient Members supporting roof attachment 100 a desired height off the roof surface such that sealant 103 does not contact the Roof Surface. In other words, the Flexible Resilient Members have a height below the bottom of base 101 greater than the thickness of sealant 103, and have a resiliency greater than the weight of roof attachment 100 to not compress such that sealant 103 is equal to or beyond the bottom surface of the Flexible Resilient Members. Upon one or more Fasteners 501 being installed through one or more Fastener apertures 108s, the torque applied to the Fasteners 501 would threadably engage with the roof to compress the head of the one or more Fasteners 501 onto Base 101, thereby compressing the one or more Flexible Resilient Members until sealant 103 contacts the roof surface. In addition, Base 101 may have one or more Base feet 203 that coincide with the roof surface when base 101 is fully installed. In this way, roof attachment 100 has transitioned from an unlocked state 400 to an installed state 500.

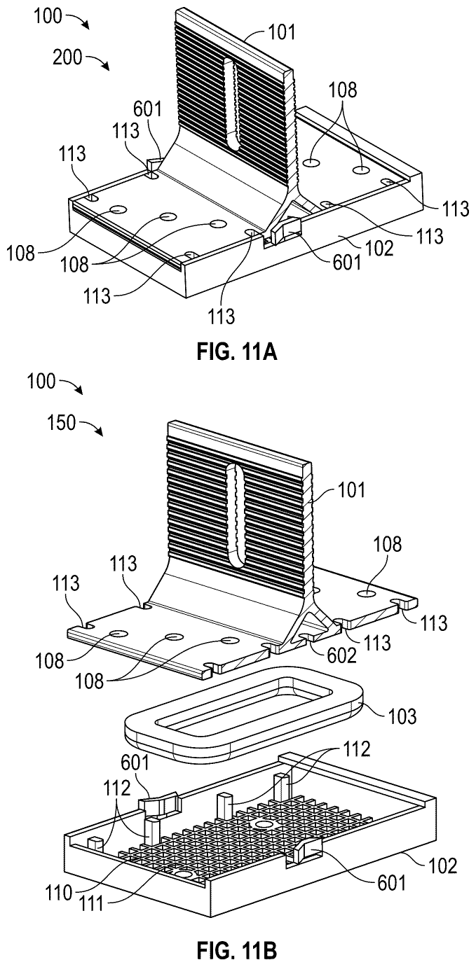

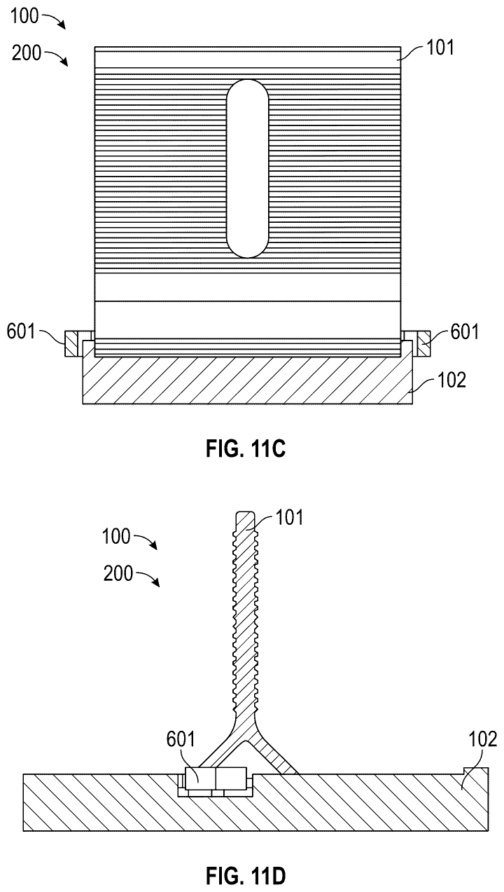

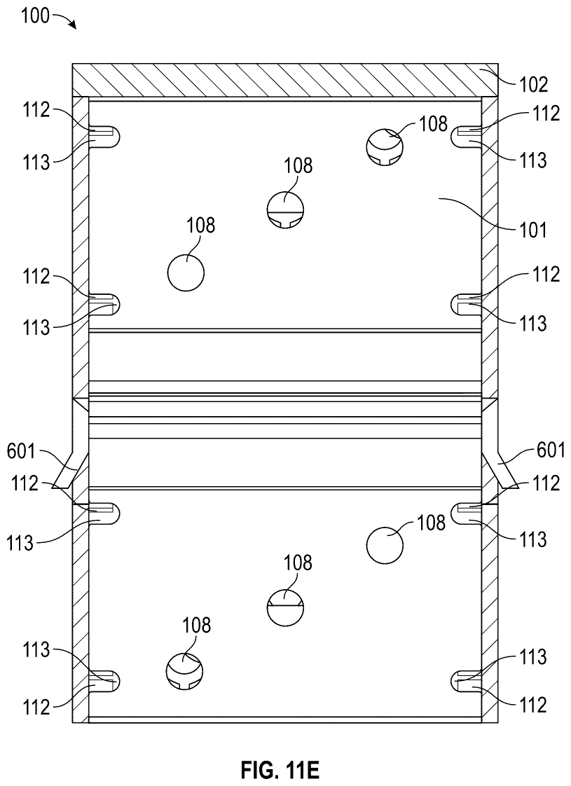

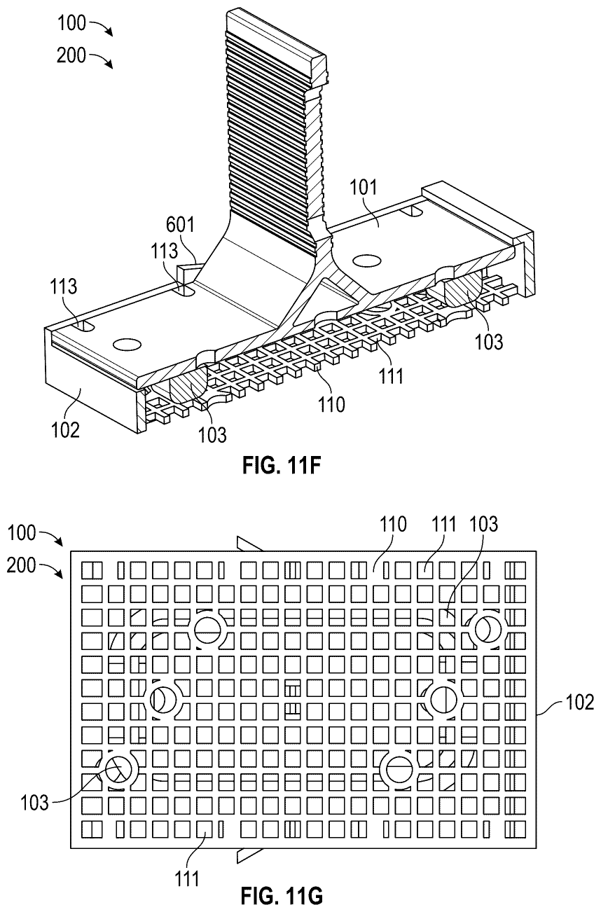

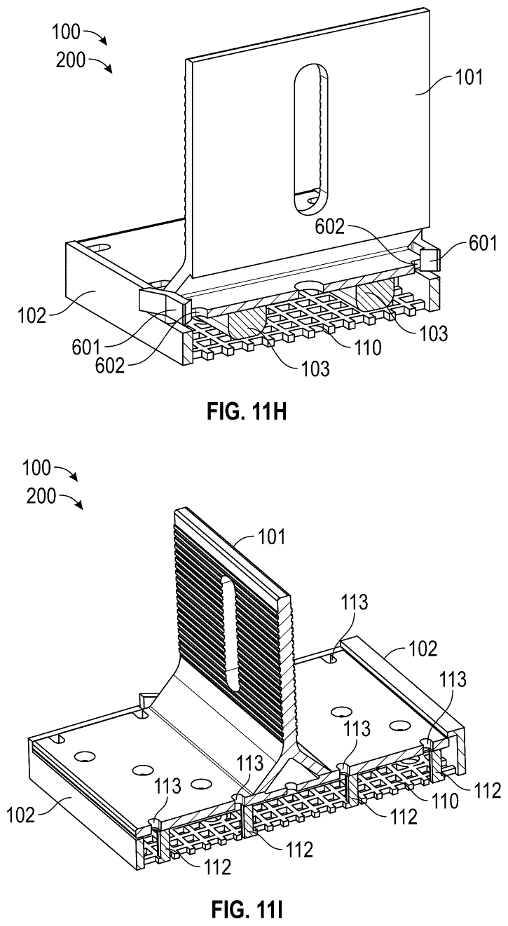

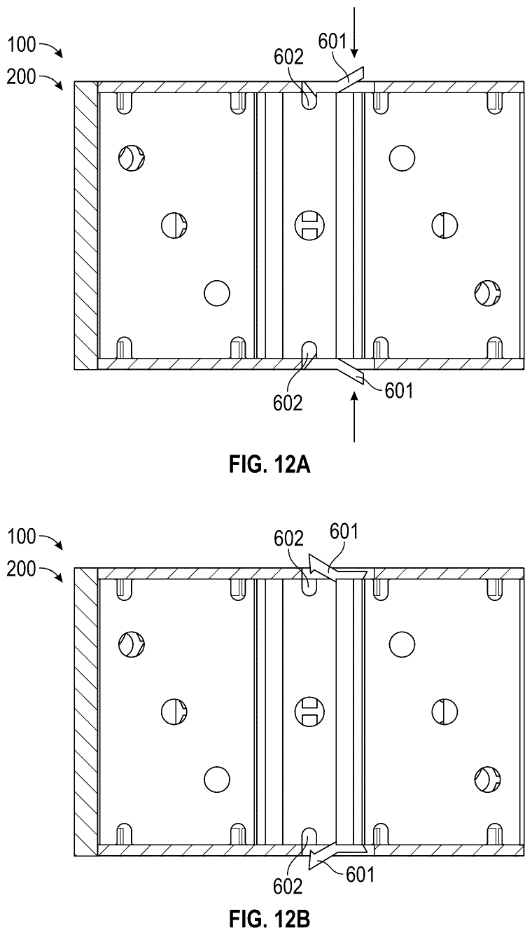

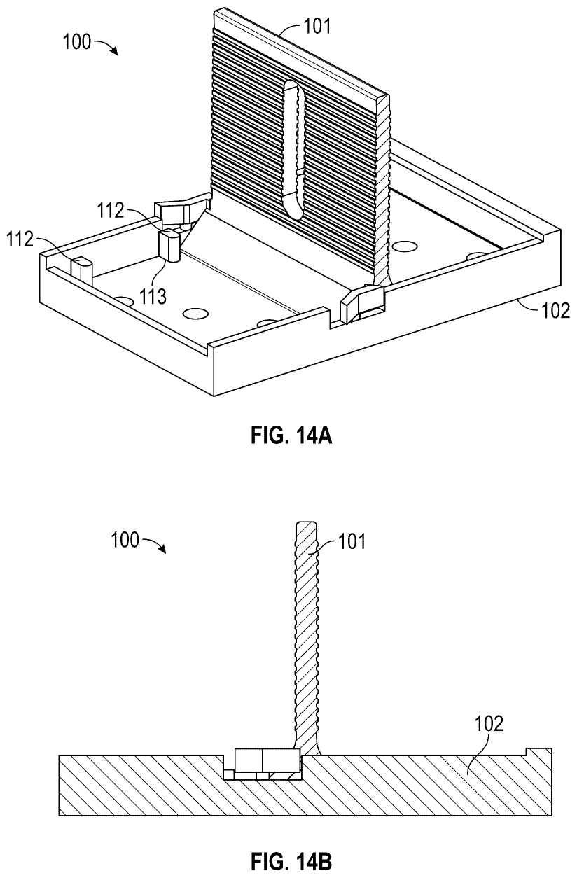

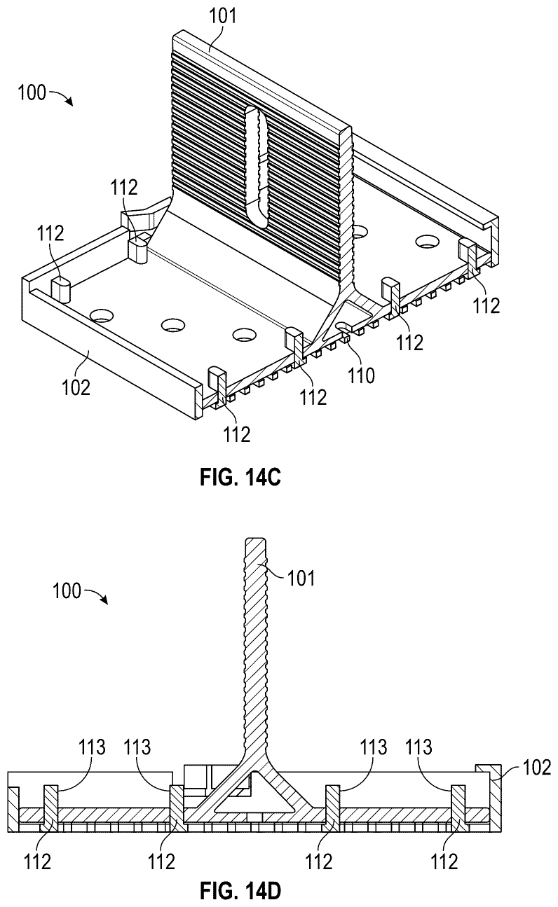

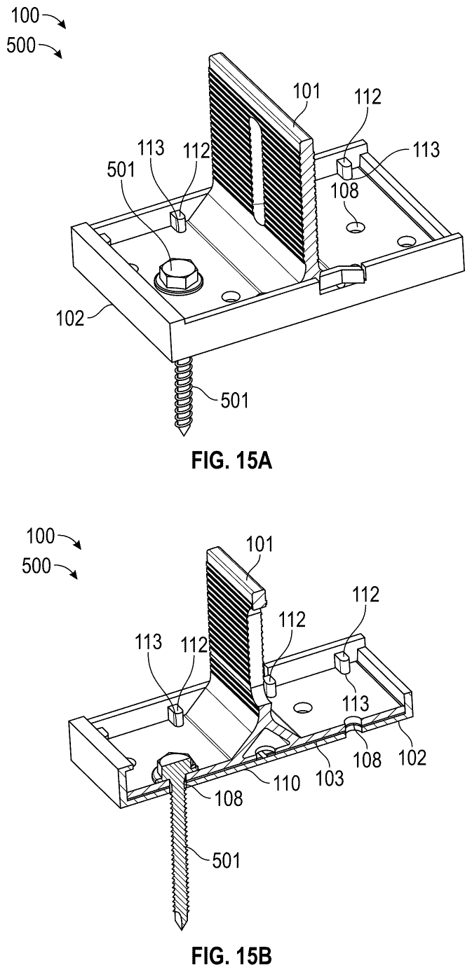

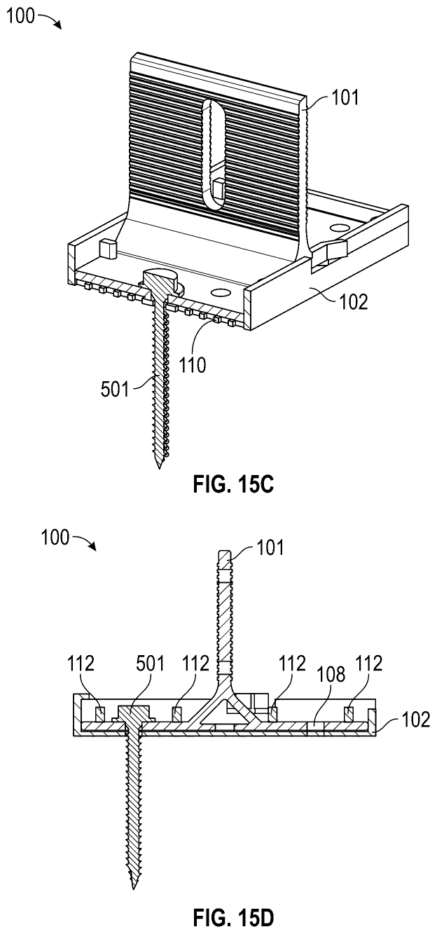

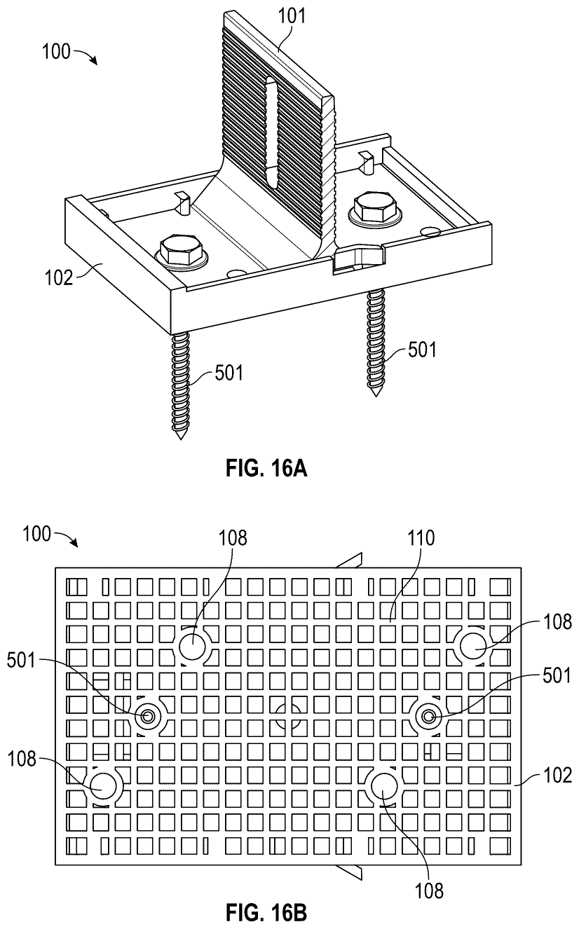

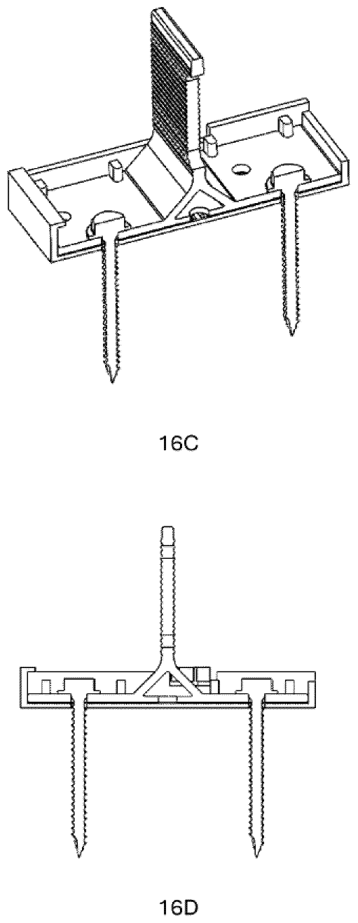

FIGS. 11 through 18 depict an alternative embodiment of roof attachment 100 where the protective cover 102 traverses relative to base 101, thereby eliminating the need for release slide 104, representing another example embodiment of the present invention. In this example embodiment, one or more 113 may be disposed along the perimeter edge and/or on the surface of the lower body of base 101. Column apertures 113 may be configured to allow one or more respective support columns 112 to traverse through when the one or more column apertures 113 are substantially aligned or concentric with the respective one or more support columns 112. Protective cover 102 may be configured traverse laterally relative to base 101 a specified distance. In some embodiments, when roof attachment 100 is in an assembled state, protective cover 102 may allow base 101 to traverse a limited distance. Protective cover may have one or more lock tabs 601 that are configured to engage with one or more lock apertures 602. The one or more lock tabs 601 may flex so that when compressed or pulled, they rotate, traverse, flex, bend, angle, deflect, move, or disengage with the lock apertures 602, thereby allowing base 101 to traverse along the length of protective cover 102 (see FIGS. 12A-12B).

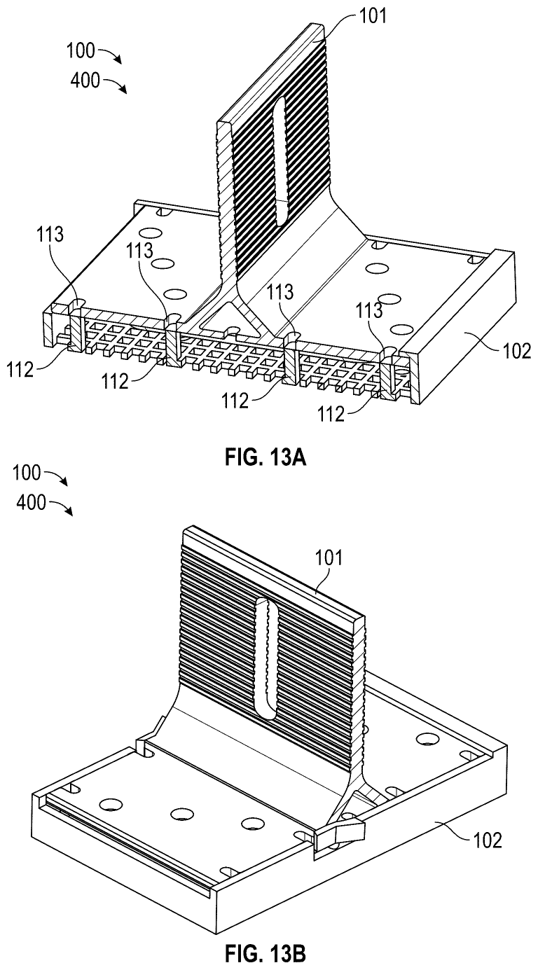

In an assembled state 200, base 101 may be positioned along the length of protective cover 102 such that one or more support columns 112 are not aligned with a respective one or more column apertures 113. In this state, base 101 would abut the top of support columns 112 and be prevented from traversing through protective cover 102 towards an installation or roof surface. Upon base 101 traversing laterally along the length of protective cover 102 so that the one or more columns support columns 112 align with the one or more column apertures 113, as depicted in FIGS. 13A and 13B base 101 may be unobstructed by support columns 112 to allow base 101 to readily traverse through protective cover 102 and towards the installation surface, thus being in an unlocked state 400. In some embodiments, one or more stop-tabs 105 may protrude laterally from the perimeter wall of protective cover 102 inwardly. When roof attachment 100 is in an unlocked state 400, base 101 may be prevented from readily traversing through protective over 102 by the support of the stop-tabs 105. Upon a first fastener 501 passing through a fastener aperture 108 disposed in the lower body of base 101 and into an installation surface, the force of the fastener 501 may cause base 101 to break one or more stop-tabs 105.

Base 101 may have sealant 103 disposed on the underside as previously described for other example embodiments.

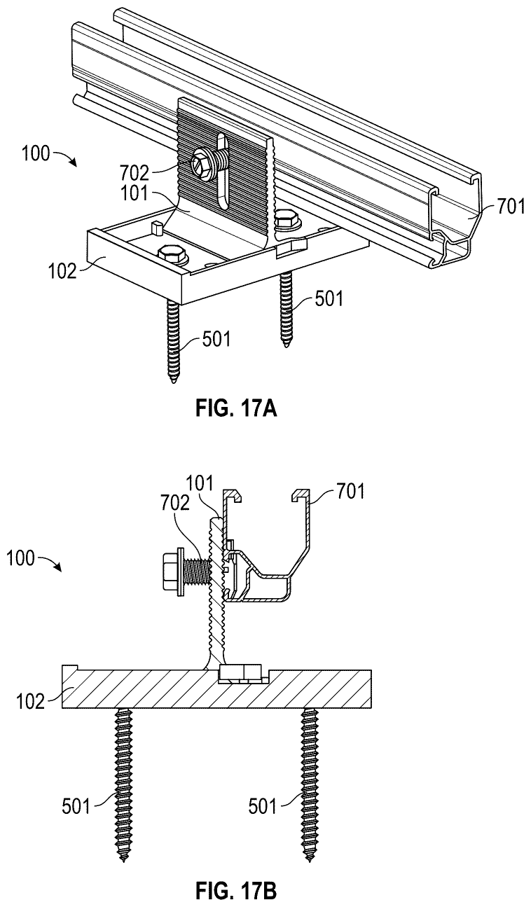

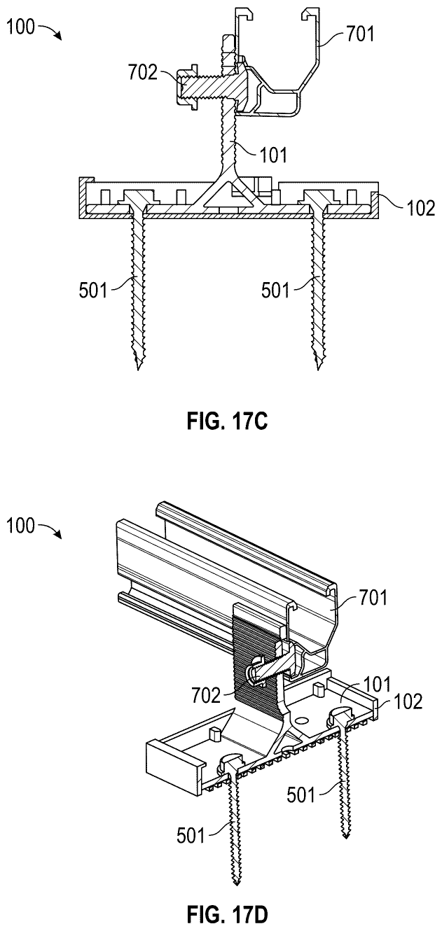

As depicted in FIGS. 17A and 17B, a rail 701 may be attached to base 101. Rail may be attached using a fastener 702, as shown, or using a clamp device. Clamp device may engage with root attachment 100 with a clamp device fastener and engage with rail 701 using one or more grooves or flanges configured to engage with one or more externally protruding flanges on the outside surface of rail. Rail 701 may have a uniform cross section along its length and made from aluminum or steel. Clamp device may have a substantially uniform cross sectional shape and made from aluminum or steel. One or more solar energy panels may be secured onto one or more rails using a panel clamp. The hex head on the fastener connecting the rail to the roof attachment 100, both on the clamp device fastener or the nut and bolt configuration, may have substantially the same size hex as on fastener 501. Fastener 501 may have a 0.375 to 0.5 inch wide hex head.

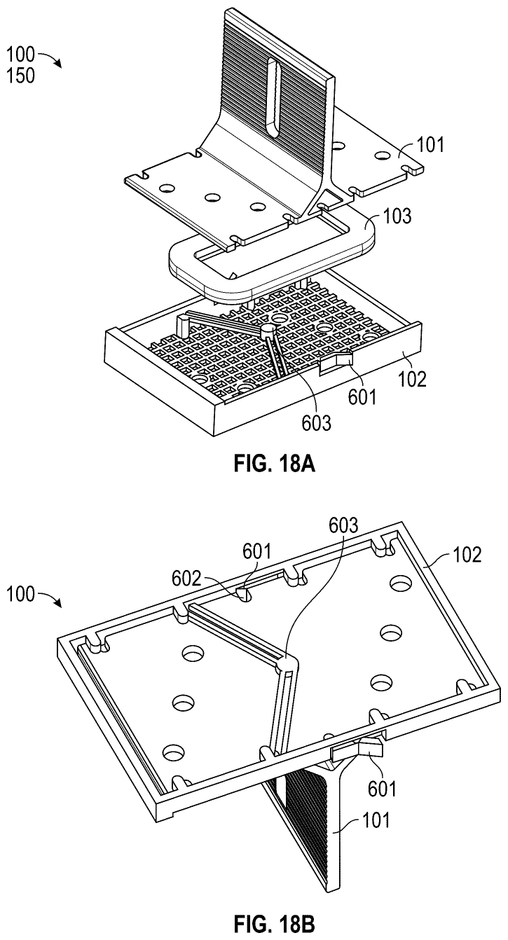

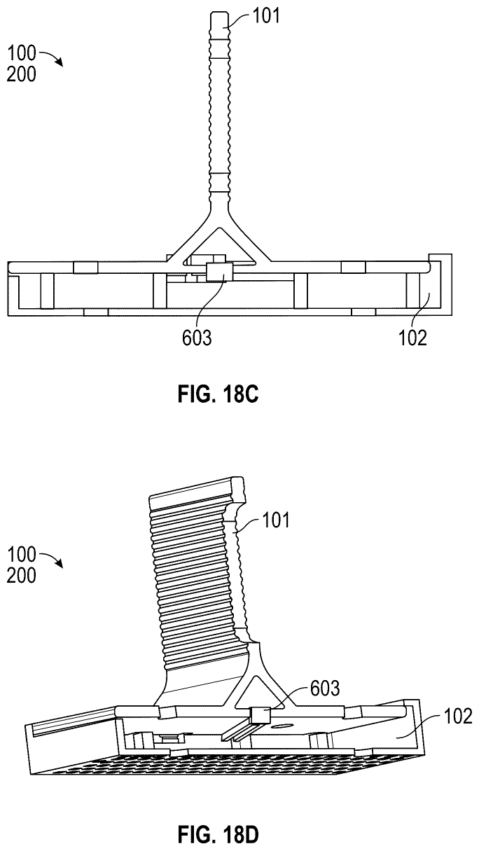

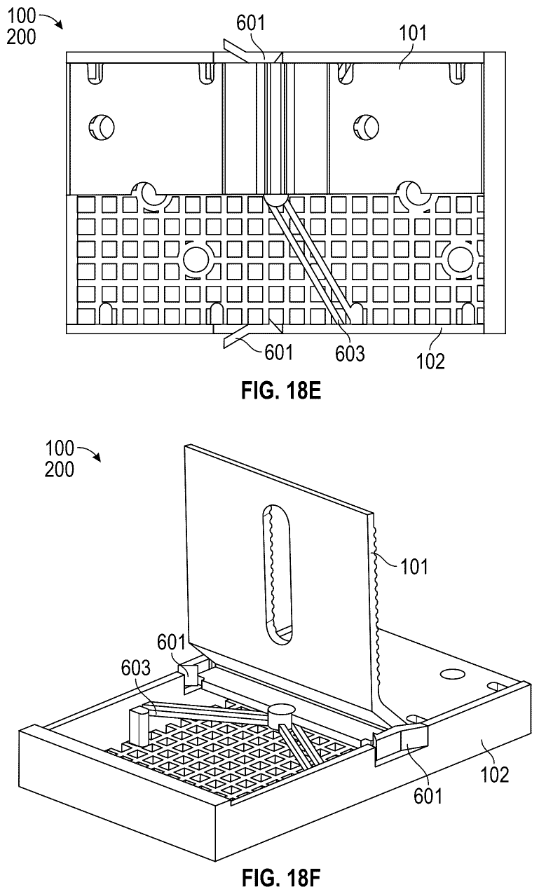

FIGS. 18A through 18F depict various views or roof attachment 100 where protective cover 102 has a resilient flexible member 603 configured to impart a force between base 100 and protective cover 102. Resilient flexible member 603 may be configured to put lateral pressure between the protective cover 102 and base 101 so that when one or more lock tabs 601 are released from one or more lock apertures (FIG. 12), the force of the resilient flexible member 603 causes protective cover 102 to traverse along the length of base 101 until base 101 abuts an end wall or side flange on protective cover 102. When base 101 abuts an end wall or one or more side flanges on protective cover 102, the one or more support columns 112 may substantially aligned with the respective one or more column apertures 113.

What is claimed is:

1. A roof attachment apparatus with incorporated sealant, the apparatus comprising:
a base;
a protective cover that includes one or more cover apertures, wherein a sealant is disposed in a space between the base and the protective cover while in a first state; and
a release mechanism that maintains the first state by preventing the base from moving towards the protective cover, wherein the release mechanism is adjustable to allow movement of the base toward the protective cover and into a second state, and wherein the movement of the base pushes the sealant through the cover apertures.

2. The apparatus of claim 1, wherein the base includes a top surface and one or more base apertures in the top surface, the base apertures configured to receive a fastener.

3. The apparatus of claim 2, wherein a width of the fastener is between 0.375 inch and 0.5 inch.

4. The apparatus of claim 2, wherein the base apertures include a wall that is pierceable by the fastener when the fastener is received by the base apertures.

5. The apparatus of claim 2, wherein installation of the fastener through a first one of the base apertures and into an installation surface causes the base to move through the protective cover, and wherein the movement of the base through the protective cover further pushes the sealant onto the installation surface.

6. The apparatus of claim 1, wherein the protective cover includes one or more tabs configured to support the base while in the first state, and wherein the tabs are further configured to break away when an amount of force is applied to the base.

7. The apparatus of claim 1, wherein the base includes one or more base apertures configured to allow one or more corresponding support structures of the protective cover to pass through a surface of the base.

8. The apparatus of claim 7, wherein the release mechanism blocks the base apertures while in the first state, and wherein the support structures cannot pass through the base apertures while the apertures are blocked by the release mechanism in the first state.

9. The apparatus of claim 7, wherein the movement of the base includes linear or rotational movement from the first state to the second state, and wherein the movement aligns one or more of the support structures with one or more corresponding base apertures.

10. The apparatus of claim 1, wherein the sealant is a butyl-based sealant.

11. The apparatus of claim 1, wherein the sealant is capable of flowing through one or more of the cover apertures at 0 °C or one or more sub-freezing temperatures.

12. The apparatus of claim 1, wherein the sealant has a cure time that is greater than one year.

13. The apparatus of claim 1, wherein the sealant is disposed in a dome-like cross-sectional shape on an underside surface of the base.

14. The apparatus of claim 1, wherein the sealant is capable of filling in one or more openings on an installation surface when pushed onto the installation surface.

15. The apparatus of claim 1, wherein the protective cover is made from a polymer.

16. The apparatus of claim 1, wherein a surface of a perimeter wall of the protective cover is angled at a non-perpendicular angle from an underside surface of the protective cover.

17. The apparatus of claim 1, wherein the base includes a body portion and one or more upright flanges extending away from the body portion.

18. The apparatus of claim 17, wherein at least one of the upright flanges has a fastener aperture configured to receive a fastener.

19. The apparatus of claim 18, wherein a thickness of the upright flanges is less than a width of the fastener that is between 0.375 inch and 0.5 inch.

20. The apparatus of claim 18, wherein the fastener is configured to secure a rail to the base.

21. The apparatus of claim 17, wherein at least one of the upright flanges includes an edge that forms an obtuse angle with a surface of the base.

22. The apparatus of claim 1, wherein the base is made from aluminum.

23. A method of incorporating sealant in a roof attachment, the method comprising:
applying a sealant onto an underside surface of a base of the roof attachment;
aligning the base to a protective cover with the sealant between the base and the protective cover; and
engaging a release mechanism that maintains a first state in which movement of the base towards the protective cover is prevented, wherein the release mechanism is adjustable into a second state that allows movement of the base toward the protective cover, and wherein the movement of the base pushes the sealant through one or more cover apertures in the protective cover.

24. The method of claim 23, further comprising:
positioning the roof attachment onto an installation surface;
adjusting the release mechanism into the second state; and
engaging a fastener to the installation surface through a base aperture on a surface of the base, wherein the engagement of the fastener to the installation surface pushes the base into moving toward the protective cover, and wherein the movement of the base pushes the sealant through one or more of the cover apertures of the protective cover and onto the installation surface.

25. The method of claim 24, wherein a support structure in the protective cover supports the base while in the first state, and wherein adjusting the release mechanism from the first state into the second state removes a barrier to the support structure and allows the support structure to pass through a base aperture in a surface of the base.

26. The method of claim 24, wherein pushing the sealant through the cover apertures includes pushing the sealant to fill in one or more openings on a surface of the installation surface.

27. The method of claim 24, further comprising attaching a rail to the base after the fastener is engaged to the installation surface.

28. The method of claim 23, wherein the sealant is a butyl-based sealant.

29. The method of claim 23, wherein the sealant is capable of flowing through the cover apertures in the protective cover at 0 °C or one or more sub-freezing temperatures.

30. The method of claim 23, wherein the sealant has a cure time that is greater than one year.
